(19) United States
(12) Patent Application Publication
(10) Pub. No.: US 2002/0132158 A1
(43) Pub. Date: Sep. 19, 2002

(54) Air electrode providing high current density for metal-air batteries

(76) Inventor: Jonathan Sassen, Ramat Bet Shemesh (IL)

Correspondence Address: LYON & LYON LLP, 633 WEST FIFTH STREET, SUITE 4700, LOS ANGELES, CA, 90071, US

(21) Appl. No.: 09/760,933

(22) Filed: Jan. 16, 2001

(51) Int. Cl. H01M 4/96; H01M 4/92; H01M 12/06; B05D 5/12

(52) U.S. Cl. 429/44; 429/42; 429/27; 29/623.5

(57) ABSTRACT

An air electrode for electrochemical cells provides high current capability over prior air cathodes. The electrode has an active layer of a carbon matrix with an oxygen reduction catalyst and a fluoropolymer binder. An embedded current collector is coated with a stable conductive material such as a conductive carbon-based paint or gold, silver, palladium, platinum, chromium, titanium, or electroless nickel. The active layer uses activated carbon made from peat which has a high BET surface area and low hardness.

### CROSS REFERENCE TO RELATED APPLICATIONS

Priority is claimed to the following United States Patent Application: Ser. No. 09/286,563, filed on Apr. 5, 1999.

### BACKGROUND OF THE INVENTION

The present invention relates to electrochemical cells such as metal-air battery cells, fuel cells, and the like. More particularly it relates to the air cathodes of such cells in applications requiring high current and concomitant high current density from battery cells.

Secondary (rechargeable) batteries power most high-drain portable electronic appliances. Examples of such high-drain appliances are cellular telephones, notebook computers, camcorders, and cordless hand-tools. The reason primary (disposable) batteries are unattractive in such applications is that their service lives are generally short, and the cost and weight are high. For example, a cellular telephone, with alkaline batteries, would last about as long as a single charge of a nickel-metal hydride battery. The cost per unit of energy of alkaline batteries is very high and, consequently, they are unattractive for that purpose. The low energy to weight ratio also makes them unattractive—a business person would have to carry a substantial weight in primary batteries to remain self-sufficient on a long trip or flight.

New battery technologies have emerged that have, in principle at least, the ability to offer much higher total stored energy at a low cost. Such technologies appear attractive for high power, high-drain appliances. One such technology is zinc-air. In zinc-air batteries, the cathode reduces ambient oxygen, which means that the battery has only a single consumable electrode. This magnifies the energy capacity per given volume tremendously. Unfortunately, this intrinsic benefit is attended by some troublesome requirements that make zinc-air batteries unattractive.

One problem is the fact that, since air must enter the battery, water vapor can leave the battery. Thus, zinc-air batteries are susceptible to dry-out in low humidity environments, potentially destroying their ability to function. The problem is exacerbated late in the discharge/shelf-storage history of the cell by the decreasing moisture content of the cathode. One prior art disclosure, U.S. Pat. No. 4,585,710, proposes an arrangement that reportedly prevents separator delamination and also helps prevent the air cathode from drying out. In this prior art disclosure, a gelling agent, such as a gelling agent commonly added to metal anodes, is applied between the cathode active layer and the separator layer to strengthen the adhesion between the separator and the cathode.

Another problem is that, while zinc-air batteries are typically high on energy density, they are generally notoriously low on power density. Generally, they are used in applications, such as hearing aids, where this is not a problem. But, in order for zinc-air batteries to generate more power, there is a need in this technology area for ways to increase the reaction rate per unit area of the cathode. Otherwise, the cathode surface area must be increased, which creates obvious practical problems for making small-size power supplied for portable appliances.

The cathode of a metal-air battery typically has an active layer of activated carbon, a catalyst, and a binder, which forms a network and holds the carbon together. Embedded within the active layer there may be a metal current collector. A guard layer covers the surface of the active layer that faces the outside air, and an ionically conducting separator covers the surface that faces the anode. The guard layer keeps electrolyte from leaking out of the cell, and the separator separates the anode, or any electrically conductive reaction product, from the cathode active layer, thereby preventing an electrical short.

Polytetrafluoroethylene (PTFE) is an example of a suitable material for the binder. Manganese oxides and hydroxides may be used as catalysts. A nickel screen is a commonly used current collector although an expanded metal sheet or an alternative conductive material can be used, instead. The guard layer can be made of a sheet of porous PTFE, and the separator can be made of a semipermeable membrane or a porous material.

Working against current density is the internal resistance of battery cells. Various different tricks may be used, many of which have been discovered by trial and error. For example, it has been found that a coating on the cathode current collector enhances the performance of the cathode as a whole. Such coatings may be metal or have a conductive filler, such as carbon. U.S. Pat. Nos. 5,447,809 and 5,814,419 discuss current collector coatings. Coated current collectors have been used in the environment of cylindrical cells (D, C, A, AA, AAA cells used widely in consumer electronics and toys) which are associated with high current per unit area. In these devices the current collector is a smooth cylindrical surface with relatively low surface area. Since the surface area is so small in this type of cell and the current demands typically so high, the smooth surface is a significant source of electrical resistance. But such coatings are not perfect. In cylindrical cells, the cathode current collector substrate is usually steel. In the '809 patent, the coating is described as being applied directly over steel. This structure would invite corrosion and is unworkable for a practical battery. The 419 patent, which follows the '809 patent corrects this problem by proposing an additive in the coating or the steel substrate of silicic acid or sodium silicate, which, according the tests reported, improves performance.

Another approach to reducing the current collector-to-cathode resistance is a higher surface area of the current collector. For example, a number of battery designs have employed rippled casing surfaces or wire mesh screens as current collectors.

There is a perennial need for greater and greater usable capacity, current capacity, and refinements in other parameters of battery cells. In the environment of air electrodes, the effectiveness of any given change is not always predictable. Consequently, advancement of the art relies heavily on empirical approaches. Advancements are commonly attributable to combinations of design features that may interact in unpredictable ways. This is certainly true in the design of air electrodes. For example, among these parameters are the type of carbon and binding materials used, the density of the electrode, coatings on the current collector, other additives in the active layer, the particular form of catalyst, etc. In addition, the optimum combination of parameters may depend heavily on the type of discharge and storage history expected for the battery. It is impossible, at the current state of the art, to be led to an optimum choice for combinations of these parameters without the slow process of experimentation.

### SUMMARY OF THE INVENTION

The invention provides a cathode for electrochemical cells with numerous advantages including high current output, high energy density, ease of manufacture, reliability, and longevity in dry environments, among others.

Briefly, an air electrode for electrochemical cells provides high current capability over prior art cathodes with a concomitant increase in energy capacity. (Note that energy capacity is related to the current capacity as indicated by the amount of energy extractable under specified load conditions before a nominal—“dead battery”—voltage is reached). The electrode has an active layer usually of an active carbon or carbon black matrix. Active carbons may include peat, coal, coconut, or wood-derived active carbons. Carbon black may be derived from partial oxidation of hydrocarbons and may be combined with the active carbons. The active layer also includes an oxygen reduction catalyst and a fluoropolymer binder. An embedded current collector may be coated with a conductive paint, plated metal including gold, silver, palladium, platinum, chromium, titanium, and electroless nickel with or without high phosphorous content. The electrode is a multilayer structure with a separator on one side of the active layer and a highly porous Teflon guard layer on the other side. The guard layer preferably has a porosity of more than 30% and a thickness of less than 100 microns.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is a schematic section view of a typical zinc-air battery cell that can make use of the air cathode of the present invention. The schematic is intended only to illustrate relationships between various components.

FIG. 2 is schematic section, partial perspective, view of an air cathode illustrating some of the embodiments of the invention.

### DESCRIPTION OF THE INVENTION

The invention provides an air-electrode for use in metal-air batteries, fuel cells, or any device that requires an air electrode, provides high current density, relative ease of manufacture, good humidity tolerance, and a number of other benefits.

The cathode described herein is intended for use in electrochemical cells, particularly metal-air battery cells, and especially zinc-air cells. The cells may be any suitable shape and may be arranged in a housing that is supplied with openings to allow air gases to be exchanged between the ambient air and the enclosed cells. The cells may have housings of metal, plastic, or any other suitable material. Each cell may have an array of air holes, such as used in zinc-air button cells, in such number and size as to allow oxygen to be supplied to a cathode inside the cell.

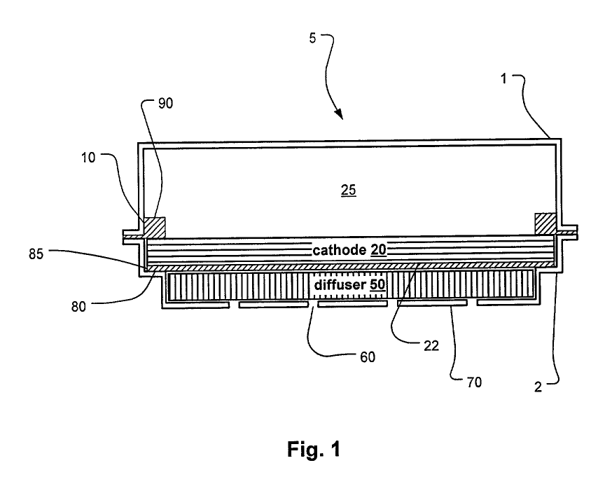

Referring to FIG. 1, each of the cells 5 contains at least one air cathode 20 and at least one zinc anode 25 with aqueous alkaline electrolyte (e.g., KOH). The cathode 20 lies adjacent a cathode side of the cell casing 2 and may be separated from that side by a diffuser 50. The diffuser 50 distributes oxygen from holes 60 in the cathode side of the cell 2 across the surface of the cathode 20 and keeps the cathode 20 at a fixed distance, equal to the diffuser's 50 thickness, from the cathode side 2 of the cell 5. The diffuser 50 may be a porous material such as woven, knitted, or non-woven cloth or extended plastic mesh material. It may act as a standoff to prevent the air-side surface 22 of the cathode 20 from smothering any of the holes 60 when an expansion of the zinc anode 25 causes the surface to press against the inside wall of the cathode side of the cell 2. The holes 60 in the cathode side of the cell 2 are uniformly distributed across the primary plane 70 of the cathode side of the cell.

The casing 1/2 of the cell may be formed in two halves, an anode side 1 and a cathode side 2 as illustrated in FIG. 1. The cell casing 1/2, may be formed from any suitable material such as metal, plastic, etc. If the casing 1/2 is made of metal or any other conductive material, the two halves 1 and 2 should be insulated from one another. In either case, to form a primary seal 80, the cathode 20 may be attached to, or sealed against, the cathode side 2 of the cell casing 1/2. The primary seal 80 may be obtained by means of a pressure seal, adhesive, or any other suitable means to prevent liquid electrolyte from leaking into the space occupied by the diffuser 50. That is, the primary seal 80 prevents liquid electrolyte from seeping around the cathode 20 into the area exposed to the outside air. A secondary seal 10 between the anode side of the cell 1 and the cathode side 2 prevents aqueous electrolyte from seeping around to the edge of the cathode 20 or leaking out of the cell 5. In the embodiment of FIG. 1, the secondary seal 10 is formed by a grommet 90, which also serves to insulate the anode side 1 and cathode side 2 of the cell casing 1/2 from each other. Pressure, an adhesive, flowing sealant, or other suitable means may be used to effect the secondary seal 10.

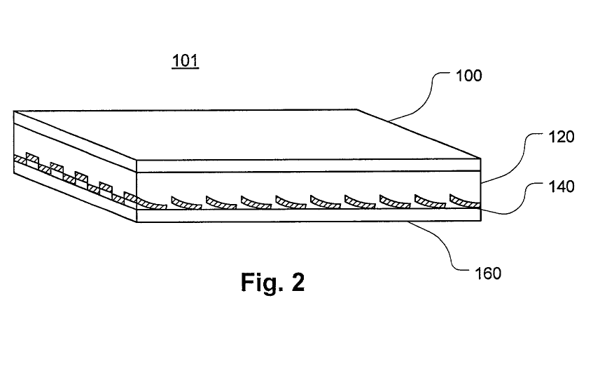

Referring to FIG. 2, in an embodiment, the cathode consists of multiple layers with the middle layer being an active layer 120 composed primarily of carbon, PTFE, and a catalyst for reducing oxygen. Note that FIG. 2 is not to scale. The active layer 120 is where the oxygen reduction reaction takes place in the presence of the catalyst. A separator layer 100 which may be prelaminated to the active layer 120 can be made from microporous hydrophilic polypropylene (PP), polyethylene, PVC, cellophane, nylon, Celgard®, or other materials exhibiting similar properties. In some applications, the pore size of the separator 100 is in the range of about 0.25 micron to 2 microns instead of the more typical average pore size of less than 0.25 micron used in other battery applications. The larger pore size is sufficient to limit electrical shorts from crystallization of zinc oxide in the separator layer 100, and still permit enhanced wetting of the cathode active layer 120 with KOH solution. Other types of separator materials that may provide better cathode performance include microporous polyethylene or polypropylene whose hydrophilicities are enhanced by radiation grafting. Another class of suitable separator materials is semipermeable membranes based on cellophane, polyethylene, PVC, nylon, and polypropylene, for example, ZAMM-0 supplied by Pall RAI Corp. An additional non-woven, absorbent material can be added between the air electrode and the microporous separator or between the microporous separator and the zinc. The purpose of this is to provide an electrolyte reservoir.

Embedded within the active layer 120 is a current collector 140 commonly formed of a metal, for example, a nickel screen. It is preferred that the current collector 140 of the cathode be treated or constructed in such a way as to provide high surface area and low electrical resistance. The formation of oxide on the surface of a metal mesh current collector or a thin film of electrolyte on the hydrophilic surface of the current collector can substantially limit the power capacity of the battery cell. Coatings of gold, silver, palladium, platinum, chromium, titanium, or electroless nickel with or without high phosphorous content over a suitable inexpensive metal mesh are preferred. A plastic element coated or clad with a conductor may also be used. Non-metal conductive coatings may also be used, for example graphite coatings.

To provide for high current capability in zinc-air batteries, the cathode should be fully saturated with electrolyte in a working battery cell. The cathode tends to dry out as a result of water evaporating from the cell and as a result of waters of hydration being drawn away from the cathode when zinc oxide forms during discharge of the cell. The addition of hydrophilic agents to the cathode ameliorates this dryout effect. For example, cellulosic materials such as Natrosol® 250 MBR hydroxyethylcellulose (HEC) may be added to the cathode material (finely divided and added to the active layer mixture). As moisture leaves the cathode during discharge, the HEC holds onto this moisture and makes it available in the cathode despite the progressive drying of the cathode. A similar material has been used as a monolithic layer, but the incorporation of the material in its finely divided form inside the cathode active layer helps to insure that moisture is held where it is needed.

In FIG. 2, which shows a cross-section of the cathode, there is a guard layer 160, preferably formed of a PTFE film, laminated to the side of the active layer facing the air holes. The guard layer 160 allows oxygen to enter the cathode while preventing liquid electrolyte from leaking out. This layer 160 is preferably unsintered and highly porous to gases. The preferred porosity is at least 30%, but it is desirable to provide a guard layer that is even more porous. Porosity of 50% or more is preferable. The preferred thickness of the guard layer is no more than 100 microns.

As visible in FIG. 1, an uncompressed PTFE film 85, which is separate from the laminated structure of the cathode 20, is uncompressed by any laminating process used to form the cathode structure shown in FIG. 2. During the manufacture of the cell, the grommet 90 forces the cathode 20 against the cathode side of the cell 2, thereby compressing the previously uncompressed PTFE film 85. This helps to form the primary seal 80, which isolates the volume of the cell that is in communication with the outside air from the electrolyte as described above. Since the film 85 is initially uncompressed, it can act as a gasket to create or augment the secondary seal. Also, as discussed above, other means may be used to effect the seal 80 and the uncompressed PTFE layer 85 is not essential for this purpose. The PTFE layers—the guard layer laminated to the cathode and the uncompressed layer—allow air to diffuse into the cathode while preventing liquid from leaking out.

In production, the active layer 120, the separator sheet 100, and the guard layer 160 may be laminated together to form a single structure. Representatively, the dimensions of the active layer and the separator layers are 0.20-0.50 mm and 0.025-0.25 mm, respectively. The actual dimensions depend on the application and can be any suitable thickness. It is preferable that the final pressure used to laminate all the layers together be limited.

An important determinant of performance in zinc-air cells used in either digital or analog cell phones, is the choice of carbon material used in the active layer. It has been discovered that carbon derived from peat, (for example, Norit®) preferably with a BET surface area of 500, or above, exhibits superior current capacity performance in zinc air cells. Tables 1 and 2 provide experimental results for various grades of peat-derived carbon and several others for comparison. Note that the analog results for Norit® SX1G are shown averaged for the GSM test results and separately for the analog tests. This is because the GSM results varied very little.

TABLE 2
Non-Peat-Based Carbon Samples

| | | | GSM Discharge | | Analog Discharge | |
|---|---|---|---|---|---|---|
| | Carbon | Iodine | Voltage at | Capacity-0.8 | Voltage at | Capacity-0.8 |
| Product | Source | Number | 40% DoD | volt cutoff | 40% DoD | volt cutoff |
| Picachem W7P | Coconut | 1100.00 | 0.95 | 3.20 | 0.88 | 2.20 |
| Picachem W8P | Coconut | 1200.00 | 0.96 | 3.30 | 0.83 | 1.50 |
| CPL PAK1420 | Wood | 1000.00 | 0.93 | 2.50 | 0.95 | 2.80 |
| Sutcliffe DCL420 | Wood | 1150.00 | 0.96 | 3.40 | 0.84 | 1.70 |
| Norit Darco KB-B | Wood/Lignin | 1500.00 | 0.98 | 3.00 | 0.84 | 1.70 |
| Jacobi AX5 | Wood | 1050.00 | 0.93 | 2.30 | 0.84 | 2.00 |

TABLE 1
Peat-Based Carbon Samples

| | | | GSM Discharge | | Analog Discharge | |
|---|---|---|---|---|---|---|
| | Carbon | BET Surface | Voltage at | Capacity-0.8 | Voltage at | Capacity-0.8 |
| Product | Source | Area | 40% DoD | volt cutoff | 40% DoD | volt cutoff |
| Norit SX Ultra | Peat | 1150 | 1.01 | 3.40 | 0.97 | 2.80 |
| Norit SX Plus | Peat | 1000 | 1.02 | 3.50 | 0.96 | 2.80 |
| Norit SX1G | Peat | 900 | 0.98 | 3.40 | 0.95 | 2.90 |
| Norit SX2 | Peat | 800 | 1.01 | 3.20 | 0.92 | 2.40 |
| Norit SX3 | Peat | 750 | 0.98 | 3.30 | 0.91 | 2.60 |

| | | | | | |
|---|---|---|---|---|---|
| Norit SX4 | Peat | 650 | 0.99 | 3.30 | Failed test |

All the above results represent averages of tests of four battery cells, each of 9.2 cm² area. Two types of discharge tests were performed at 71° C. after the cells had aged for a period of 3 weeks. The load for simulating a digital cell phone (“GSM”) was a square wave load of 2 Amperes for 0.55 msec. followed by 0.2 amperes for 4.05 msec. The load for simulating an analog cell phone was 0.8 amperes continuous. The voltages (“Voltage at 40% DoD”) indicate the voltage after 40% of the zinc in the battery cell is consumed. As can be seen from the above chart, generally speaking, the peat-based activated carbons exhibit higher average voltage at 40% discharge and higher energy capacity in both the GSM and analog discharge regimes than the non-peat-based activated carbons. This effect is not simply due to a difference in surface area as can be seen the surface areas of the two types of carbon overlap, noting that iodine number and BET surface area are approximately the same.

The advantage of peat-based activated carbons in the active layer of an electrode is apparent in applications where both analog and digital discharge regimes in the relatively high current range may be experienced by the battery. In traditional applications where zinc-air batteries are used, the peak current density is much lower than that experienced by the cells in the above experiments. This is particularly true of the GSM discharge regime. The higher BET surface area cells among the peat-based activated carbons exhibited better performance than lower BET surface area carbons. The falloff in capacity with BET surface area is more clear in the case of the analog load simulation. Thus, in devices exhibiting a load more like that of the GSM discharge regime, the BET surface area is not a sensitive parameter.

Tests of wood-based activated carbon (Carbochem CA10) showed very high initial impedance which makes them impractical in the above current regimes. Another activated carbon tested is Lufgi HTPUR Carbopal which also had a high initial impedance.

Norit® SX Ultra is produced by steam activation from peat. It is acid washed and has a maximum molasses number (measure of macroporosity) of 200. It contains a maximum of 200 mg./kg. iron and a maximum of 10 mg./kg of copper. Norit SX Plus is essentially the same except that it has a maximum molasses number of 245. Norit SX2 differs in that it has a maximum molasses number of 380. Norit SX1G has a maximum molasses number of 310.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

We claim:

1. An air cathode for an electrochemical cell connectable to a load that draws a peak current density of about 0.2 A./cm.2, at a duty cycle of about 1/10, comprising:
an active layer including a mixture of a divided mass of peat-based activated carbon, a binder, and a catalyst compressed around a conductive current collector;
said current collector being of a substrate with a conductive coating.

2. A cathode as in claim 1, wherein said coating is a non-metallic conductive coating principally of carbon and resin.

3. A cathode as in claim 1, wherein said coating includes one of gold, silver, palladium, platinum, chromium, titanium, and electroless nickel.

4. A cathode as in claim 1, wherein said peat-based activated carbon has a BET surface area of 500 or more.

5. A cathode as in claim 4, wherein said coating includes one of gold, silver, palladium, platinum, chromium, titanium, and electroless nickel.

6. A cathode as in claim 4, wherein said coating is a non-metallic conductive coating principally of carbon and resin.

7. A battery power supply for connection to a pulsatile load that draws a peak current density of about 0.2 A./cm.², at a duty cycle of about 1/10, comprising:
a zinc air cell containing an air electrode;
said air electrode containing an active layer including carbon;
said carbon having the properties of activated carbon produced from peat by steam activation;
said air electrode having a current collector, said current collector being of metal having a coating of one of gold, silver, palladium, platinum, chromium, titanium, and electroless nickel or a conductive non-metal paint including a carbon-containing pigment.

8. A power supply as in claim 7, wherein said pulsatile load has a minimum current load of 0.02 amps steady state load between current pulses.

9. A power supply as in claim 7, wherein said activated carbon has a BET surface area of 500 or more.

10. A battery power supply for connection to a pulsatile load that draws a peak current density of about 0.2 A./cm.², at a duty cycle of about 1/10, comprising:
a zinc air cell containing an air electrode;
said air electrode containing an active layer including activated carbon;
said carbon having the properties of activated carbon produced from peat by steam activation;
said air electrode having a current collector, said current collector being of metal with a conductive coating.

11. A power supply as in claim 10, wherein said pulsatile load has a minimum current load of 0.02 amps steady state load between current peaks.

12. A power supply as in claim 11, wherein said coating includes one of gold, silver, palladium, platinum, chromium, titanium, and electroless nickel.

13. A power supply as in claim 11, wherein said coating is a non-metallic conductive coating principally of carbon and resin.

14. A power supply as in claim 10, wherein said coating includes one of gold, silver, palladium, platinum, chromium, titanium, and electroless nickel or a conductive non-metal paint including a carbon-containing pigment.

15. A power supply as in claim 10, wherein said peat-based activated carbon has a BET surface area of 500 or more.

16. A zinc air battery cell, comprising:
a cathode having an active layer that includes a mixture of a divided mass of peat-based activated carbon, binder, and a catalyst compressed around a conductive current collector;
said current collector being coated with a non-metallic paint containing graphite as a pigment or one of gold, silver, palladium, platinum, chromium, titanium, and electroless nickel;
said battery cell being for connection to a current load of at least approximately 0.2 A. per cm².

17. A method of forming and using a zinc air battery cell, comprising:
forming a cathode having an active layer that includes a mixture of a divided mass of peat-based activated carbon, binder, and a catalyst compressed around a conductive current collector;
said current collector being coated with a non-metallic paint containing graphite as a pigment;
combining said cathode with a zinc anode to form a zinc air cell;
connecting said zinc air battery cell to a current load of at least approximately 0.2 A. per cm².

18. A battery power supply for connection to a pulsatile load that draws a peak current density of at least 0.2 A./cm.², comprising:
a zinc air cell containing an air electrode;
said air electrode containing an active layer including activated carbon;
said activated carbon having the properties of activated carbon produced from peat by steam activation;
said air electrode having a current collector, said current collector being of metal coated with one of gold, silver, palladium, platinum, chromium, titanium, and electroless nickel.

19. A power supply as in claim 18, wherein said pulsatile load has a minimum current load of 0.02 amps steady state load between current pulses.

20. A power supply as in claim 19, wherein said coating is a non-metallic conductive coating principally of carbon and resin.

21. A power supply as in claim 18, wherein said coating includes one of gold, silver, palladium, platinum, chromium, titanium, and electroless nickel.

22. A power supply as in claim 18, wherein said coating is a non-metallic conductive coating principally of carbon and resin.

23. A power supply as in claim 18, wherein said peat-based activated carbon has a BET surface area of 500 or more.

24. A power supply as in claim 23, wherein said coating is a non-metallic conductive coating principally of carbon and resin.

25. A power supply as in claim 18, wherein said coating includes one of gold, silver, palladium, platinum, chromium, titanium, and electroless nickel.
